(19) United States
(12) Patent Application Publication
(10) Pub. No.: US 2021/0049488 A1
(43) Pub. Date: Feb. 18, 2021

(54) SYSTEMS AND METHODS FOR UNIVERSAL MONITORING AND ACTION

(71) Applicant: AllHere Education, Inc., Boston, MA (US)

(72) Inventor: Joanna Smith, Durham, NC (US)

(73) Assignee: AllHere Education, Inc., Boston, MA (US)

(21) Appl. No.: 16/994,517

(22) Filed: Aug. 14, 2020

Related U.S. Application Data
(60) Provisional application No. 62/887,295, filed on Aug. 15, 2019.

(51) Int. Cl. G06N 5/04; G06F 16/2455; G06N 20/00; G09B 19/00

(52) U.S. Cl. CPC G06N 5/04; G09B 19/00; G06N 20/00; G06F 16/24558

(57) ABSTRACT

Various embodiments address problems with managing student engagement and managing the need to identify and resolve underlying causes for problem behavior and other schooling issues (e.g., attendance, etc.). Embodiments can be provided and tailored to respective school systems, school districts, and/or custom student bodies. For example, the system can include components to manage communication with students and/or families based on defined communication triggers, continuous analysis of students and modeled parameters (e.g., intelligent models), communication scripting, etc. The system can use automatic communication sessions as intervention for students having or predicted to have issues with engagement, as well to identify or derive sources for engagement issues. Various embodiment train intelligent models to select communications automatically that elicit information, and to provide responsive communication automatically to identified issues. Each communication session can be used to update intelligent models and improve communication, and further improve student engagement.

### RELATED APPLICATIONS

This application is a non-provisional application claiming priority under 35 U.S.C. § 119(e) to U.S. Provisional Application No. 62/887,295, filed on Aug. 11, 2020, titled “SYSTEMS AND METHODS FOR UNIVERSAL MONITORING AND ACTION,” which application is incorporated herein by reference in its entirety.

### BACKGROUND

Engaging students in school activity and learning can prove challenging across a student body. Each student has their own unique issues. Determining when and how to interact with each student is a task that has overwhelmed our current school administration. Various conventional systems exist try to facilitate management of students and their engagement. However, these systems are architected to provide tracking functionality for students and some also provide for tracking operations regarding student issues, but tracking operations are not sufficient to resolve causes or provide intervention.

### SUMMARY

The inventors have realized that there is an unmet need for monitoring and intervention systems that can derive problem sources for students and act to resolve them automatically. School settings present a number of challenges to effective problem tracking within a student body, and resolving problems based on, for example, identification of the source of a given issue. Current circumstances have further complicated this challenging set of problems as school administrators are forced to cope with remote learning under pandemic conditions. Conventional systems in this space approach issues as an attendance tracking problem, but do not provide analysis of causation, and do not enable action based on modeling effective results. Thus, conventional tracking systems fail to address the underlying cause for school issues, and ultimately only track the re-occurrence of problems rather than establishing actions and/or interventions to proactively resolve them.

Accordingly, various aspects of the disclosure address the need to identify and resolve underlying causes for problem behavior and other schooling issues (e.g., attendance, etc.). While some conventional approaches are available to address underlying causes (e.g., counselors, therapists, etc.), these conventional approaches still fail to develop universal descriptions of underlying issues, develop root causes across a scalable body of student information, and fail to enable review of, and incorporation of, intervention information. Further, such conventional approaches likewise fail to provide analysis of efficacy of such intervention. Conventional approaches simply lack the universal data format that enables consistent identification of issues, association of such issues to root causes (e.g., automatically by system analysis (e.g., machine learning algorithms, etc.) or based on human prompted input), recommendations on intervention types and content, as well as heuristic analysis of prior intervention execution.

According to one aspect, a monitoring and response system is provided. The system comprises at least one processor operatively connected to a memory; a monitor component, executed by the at least one processor, configured to automatically capture student location and activity data (e.g., attendance, GPS, in school location, after school activity, school events, grades, homework completion, remote learning, remote submissions, etc.); a machine learning component configured to match student location and activity data to student performance models and trigger intervention via an automated chat interface responsive to a prediction of reduced performance; and the automated chat interface configured to select scripted communication elements responsive to an intervention trigger; request responses from a respective that include student generated causal information; and select one or more communication responses based at least in part on student response, context, and machine learning models of effective communication responses. According to one embodiment, the system further comprises an analysis component, executed by the at least one processor, configured to associate student status events (e.g., attendance, absence, excused time, etc.) with causal information (e.g., root cause identifier, etc.); analyze student location data to determine a student status event; and analyze at least one of a student status event or student location data to automatically determine a causal identifier associated with the student status event. According to one embodiment, the system further comprises a response component configured to analyze trigger information (e.g., root cause, %/# of absences, excused/un-excused, location data, etc.), and automatically determine intervention options. According to one embodiment, the response component is configured to execute an identified intervention option automatically. According to one embodiment, the system further comprises a communication model trained on a body of prior student communication and effectiveness of the communication. According to one embodiment, the communication model is configured to select communication options based on matching model parameters to a respective student. According to one embodiment, the communication model is further configured to manage bi-directional communication with the respective student based on matching a current communication and context to a communication option in the trained model. According to one embodiment, the communication model is further configured to match at least one student response and context to an alert classification. According to one embodiment, the system is further configured to generate and communicate an alert to a response team responsive to determining the match to the alert classification. According to one embodiment, the at least one processor is further configured to trigger scheduled communication sessions with respective students, and automatically identify and communicate response options to returned communication from the respective students. According to one embodiment, the at least one processor is further configured to track communication sessions and update machine learning models based on tracked interactions.

According to one aspect, a computer implemented method for monitoring and responses is provided. The method comprises automatically capturing, by at least one processor, student location and activity data (e.g., attendance, GPS, in school location, after school activity, school events, grades, homework completion, remote learning, remote submissions, etc.); matching, by the at least one processor, student location and activity data to student performance models; executing an intervention trigger intervention via an automated chat interface responsive to a prediction of reduced performance output by the student performance model; selecting, by the at least one processor, scripted communication elements responsive to the intervention trigger; requesting, by the at least one processor, responses from a respective that include student generated causal information; and automatically selecting, by the at least one processor, one or more communication responses based at least in part on student response, context, and machine learning models of effective communication responses. According to one embodiment, the method further comprises associating student status events (e.g., attendance, absence, excused time, etc.) with causal information (e.g., root cause identifier, etc.); analyzing student location data to determine a student status event; and analyzing at least one of a student status event or student location data to automatically determine a causal identifier associated with the student status event. According to one embodiment, the method further comprises a response component configured to analyze trigger information (e.g., root cause, %/# of absences, excused/un-excused, location data, etc.), and automatically determine intervention options. According to one embodiment, the method further comprises executing an identified intervention option automatically. According to one embodiment, the method further comprises executing a communication model trained on a body of prior student communication and effectiveness of the communication. According to one embodiment, executing the communication model includes selecting by the communication model, communication options based on matching model parameters to a respective student. According to one embodiment, executing the communication model includes managing bi-directional communication with the respective student based on matching a current communication and context to a communication option in the trained model. According to one embodiment, executing the communication model includes matching at least one student response and context to an alert classification, and the method further comprises generating and communicating an alert to a response team responsive to determining the match to the alert classification. According to one embodiment, the method further comprises triggering scheduled communication sessions with respective students and automatically identifying and communicating response options to returned communication from the respective students. According to one embodiment, the method further comprises tracking communication sessions and updating machine learning models based on tracked interactions.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE FIGURES

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of an example system, according to one embodiment;

FIG. 2 is a block diagram of example system elements and process flow, according to one embodiment

FIG. 3 is an example screen capture of a user interface, according to one embodiment;

FIG. 4 is an example screen capture of a user interface, according to one embodiment;

FIG. 5 is an example screen capture of a user interface, according to one embodiment;

FIG. 6 is a block diagram of a special purpose computer system that can be modified to execute the functions, operations, and/or processes described, according to one embodiment;

FIG. 7A-C illustrate screen capture examples, according to some embodiments;

FIG. 7D illustrates an example communication template, according to one embodiment;

FIG. 8 is an example communication including survey information, according to one embodiment;

FIG. 9-10 are screen captures of example communication streams, according to one embodiment;

FIG. 11 is an example communication including survey information, according to one embodiment;

FIG. 12 illustrates an example communication template, according to one embodiment;

FIG. 13 is an example process flow, according to one embodiment; and

FIG. 14 is an example process flow, according to one embodiment.

### DETAILED DESCRIPTION

Various embodiments of a monitoring and intervention system address problems with managing student engagement, and further embodiments manage the need to identify and resolve underlying causes for problem behavior and other schooling issues (e.g., attendance, etc.). The monitoring and intervention services can be provided and tailored to respective school systems, school districts, and/or custom student bodies. The system can include components to manage communication with students and/or families directly, based on defined communication triggers, continuous analysis of students and modeled parameters (e.g., intelligent models), communication scripting, etc. The system can use automatic communication sessions as intervention for students having or predicted to have issues with engagement, as well to identify or derive sources for engagement issues. Various embodiment train intelligent models to select communications automatically that elicit information on potential issues, and to provide responsive communication automatically to identified issues. If the intelligent model fails to identify a response, a template answer can be selected, and an alert generated to a response team.

The capability to communicate automatically in student engagement settings, enables various embodiments to automatically deliver intervention to students needing interaction, reminders to students who can be identified based on prediction of needed interaction, among other options that are unavailable in conventional systems. In various settings, the automatic functions and communications enable automatic interactions with student bodies and families at a scale that cannot be achieved in conventional systems, nor replicated by current administration.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

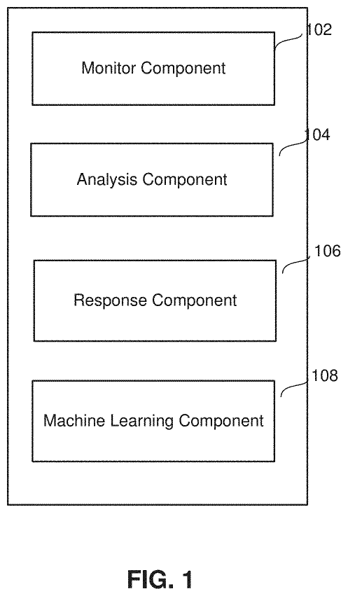

FIG. 1 is an example monitoring and execution system 100. According to various embodiments, system 100 can provide options for monitoring, identifying and automatically executing interventions for a student body or individual students based on identified student activity (e.g., absence, behavior issues, etc.). In various embodiments, system 100 can be configured to analyze student record information and trigger human based input via web interfaces or by communicating and/or processing returned e-mail communication. In further embodiments, the system 100 can be configured to automatically identify an intervention action and automatically trigger that action in response to analysis of student record information. In some embodiments, system 100 can process and/or receive student record information in real time, and trigger interventions in real time.

According to various embodiments, system 100 can include a plurality of components each associated with specific or specialized functions. In other embodiments, system 100 can be configured to execute without individual components, and any of the functions discussed herein can be executed by the system 100 more generally.

According to one embodiment, system 100 can include a monitor component 102 configured to access or receive student record information, which tracks various metrics on a student body (including for example, attendance or absence information). The student record information can also include information on any interventions associated with a given student. In some examples, monitor component 102 is configured to retrieve student record information from one or more databases detailing attendance information and/or one or more databases detailing intervention information. In further examples, the monitor component 102 can be configured to access student location information to gather data on daily attendance, class attendance, activity attendance, schedule conformity, etc. In further examples, the student may download or activate an application on a respective mobile device configured to communicate location information to the monitor component 102. In other examples, school provided devices can communicate location information to the monitor component 102 (e.g., to determine attendance).

In further embodiments, system 100 can include an analysis component 104 configured to analyze student record information and associate identified issues (e.g., absence) with a root cause. In some examples, the root cause can be input by administrator users. In other examples, the system can analyze student record information to determine a model or similar student, and the model or similar student can be used to extrapolate a root cause automatically. In yet other embodiments, machine learning analysis can be performed on student record information and known root cause information used as training data (e.g., via machine learning component 108). The machine learning algorithm can then identify root cause information automatically given student records inputs. In one example, the machine learning model can be trained on student behaviors and causality, and the model, once trained can automatically identify cause, and in further embodiments, some machine learning models can generate and trigger execution of interventions that achieve improved outcome (e.g., based on historic analysis and/or modelling).

In some embodiments, machine learning analysis can include a target output encoded as student attendance improving month over month, where inputs to the ML analysis include student root cause, grade level, grades, behavioral notes, interventions to date, etc. The ML algorithm can be trained against data obtained on a student population, and the trained algorithm executed to identify interventions with the most impact on improving attendance, among other options, where different ML models can be tailored to identify interventions to improve a target goal (e.g., improving attendance, increasing participation, increasing activity, etc.). According to some embodiments, a machine learning model can be architected based on a deep reinforcement learning model using convolutional neural networks.

In further embodiments, the analysis component 104 can also access information on intervention types and intervention content for respective students. In some embodiments, machine learning algorithms can facilitate automatic selection of interventions based on identified issues, root causes, and evaluations of intervention types and content (e.g., beneficial intervention, etc.). In various embodiments, identification of issues within the student record information can be configured to automatically trigger intervention options (e.g., text or e-mail to respective student, respective parent or guardian, trigger remote counseling sessions, among other examples).

In further example, the analysis component 104 can evaluate pre-defined rules to determine if an intervention should be triggered. The general format for trigger based rules includes a [root cause] variable for evaluation and/or [threshold # or % of occurrence of event (e.g., absences) which can be compared to normative values for a data population or sample (e.g., school average absences, district average absences, etc.).

According to one embodiment, the trigger rules can also specify an [intervention frequency] variable and/or [intervention type] and/or [intervention content] variable. Each optional declaration can trigger the system to behave differently on matching to the preceding variables. Some example rules executed by the analysis system can specify a variable for root cause and a test condition (e.g., being equal to “disengagement”). Further, the rule can specify a threshold value for an issue. In one example, the threshold value can specify absences exceeding 10 for a respective student. According to one embodiment, if the root cause and the threshold are validated, the matched rule will cause the system to trigger an intervention. In this example, the intervention executed automatically by the system causes a weekly text message to a target recipient (e.g., the respective student, parent, or guardian, etc.). In another example, a rule can specify for any student if absences exceed 10% of population average trigger a specified intervention.

Example interventions include tailored emails having multiple versions. In other examples, interventions can include tailored emails, text messages to students or parents, physically mailed letters to a student/parent home, among other options. In further example, each intervention can be customized with data about the student issue, such as total absences missed or missing assignments. The analysis component 104 can select from multiple versions based on historic use and efficacy information associated with the specific intervention.

According to some embodiments, the system can include a response component 106 configured to manage execution of any selected intervention. For example, the analysis component can identify a rule and matching criteria, which causes the response component 106 to access any information on the associated intervention and execute the same. For example, the system can automate communications, trigger beacon signals on student and/or school devices, activate location devices, activate passive location sensors (e.g., in school), among other options. In some embodiments, the response component 106 is further configured to associate effectiveness information on any particular intervention. The effectiveness can track at a high level (e.g., success or not) and can include more granular effectiveness. In one example, the system can evaluate effectiveness based on recurrence analysis over time (e.g., no recurrence over first time period—score or value, for second period (e.g., longer or short) period of time—higher or lower score value, etc.).

In further embodiments, system 100 can include a machine learning component 108 configure to analyze historic information to determine models for ML analysis on current data. In one example, the ML component 108 can generate a model for student behavior and root cause, enabling automatic identification of the same based on monitored information. In another example, the ML component 108 can automatically select interventions based on prior intervention selection models, and/or prior selection models augmented with effectiveness information, or in conjunction with separate effectiveness ML models.

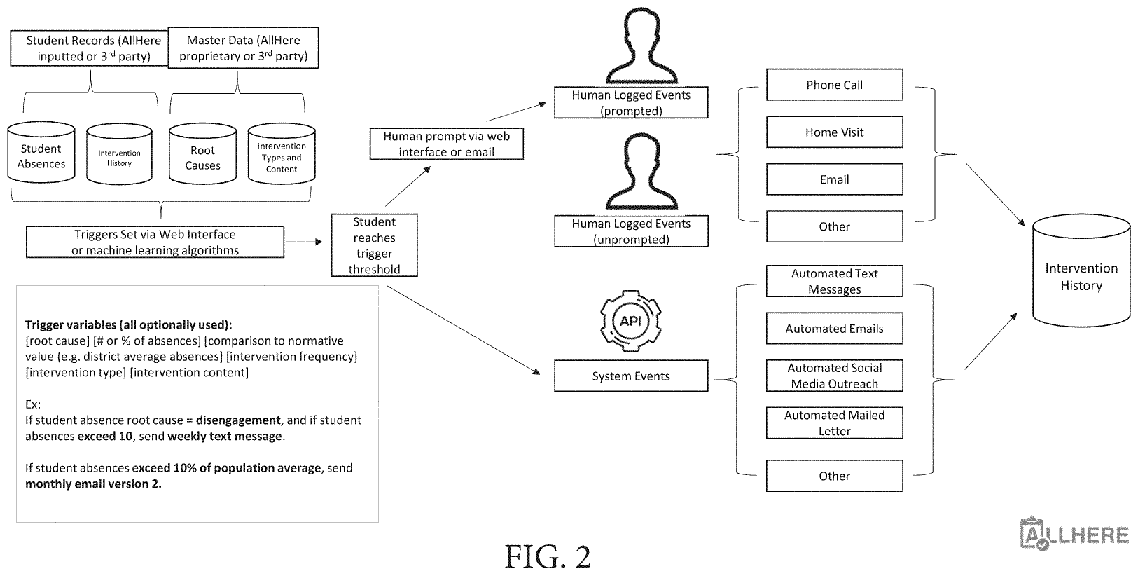

Shown in FIG. 2 is a block diagram of system elements and process flow, according to one embodiment. According to some embodiments, various databases store information associated with student records intervention history (e.g., root causes, intervention types, intervention content, intervention manager, etc.). The system can be configured to analyze the information in the respective databases and determine if criteria for a trigger is met.

According to some embodiments, the various triggers can be set via user interfaces, web interfaces, or other communication pathways to the system. In other embodiments, machine learning algorithms can define rules and triggers and/or interventions. In yet other examples, machine learning algorithms can analyze student record information and trigger interventions based on modeling intervention rules and historic interventions applied.

Returning to FIG. 2, once the system determines the student has reached a trigger threshold the system can trigger human managed operation or automatic system events. According to one embodiment, the system communicates problems and/or prompts to administrators via web interface, email, text message, etc. in some examples, the web interface or email or text message include executable links or information that trigger respective user interfaces on the system.

According to one embodiment, the user interfaces can provide directed interaction for the administrator. The user interfaces can also provide unprompted logging. In some examples, the logged events include the administrator calling the respective student, visiting the home of the respective student, emailing the student, or taking other action. According to various embodiments, the action selected and the outcome can be recorded in an intervention history database. The intervention history database can then be analyzed by the system for subsequent selection of interventions. The subsequent selection can include displays of the historic intervention information for human managed interaction and/or can be analyzed via machine learning algorithms for automated use.

Returning to FIG. 2, the system includes application programming interfaces (API) for triggering third-party systems (e.g., text messaging, email services, videoconferencing, automated phone calls, etc.). Responsive to student information meeting trigger thresholds the system can communicate via API to selected third-party systems. In various examples, multiple systems can be selected for executing multiple interventions. In some examples, the system can trigger interventions on social media as a communication platform.

According to various embodiments, the intervention and associated information (which may include efficacy information) can be saved to an intervention history database. Similar to human managed interventions and history, subsequent interventions can analyze the historic information to inform selection of new or continued interventions.

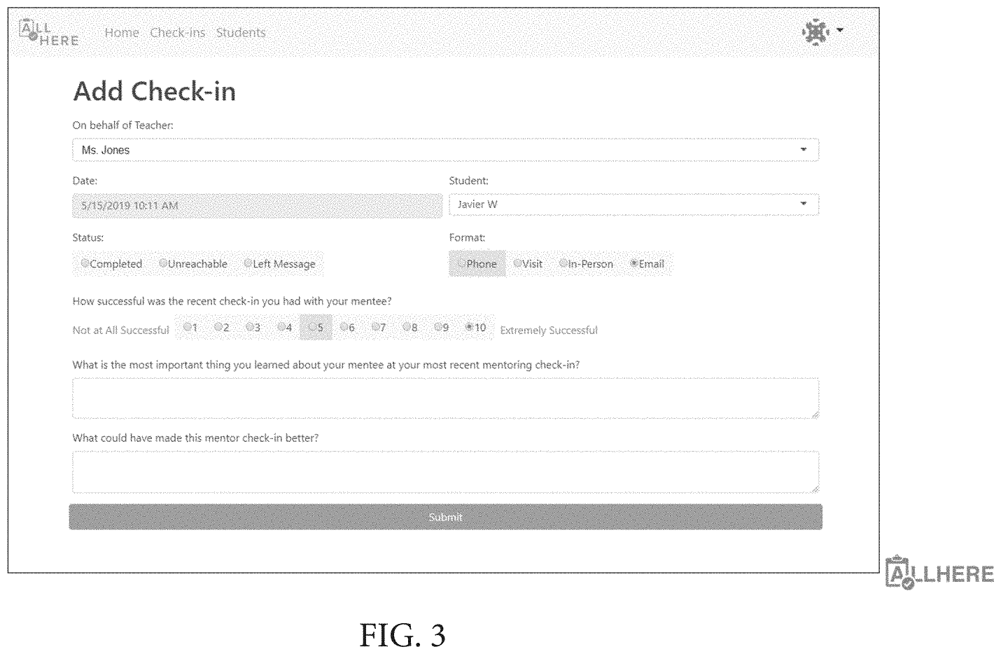

Shown in FIG. 3, is one embodiment and example user interface displayed by the system (e.g., system 100). For example, the user interface enables creation of a check in action.

According to one embodiment, the user interface enables an administrator to select a respective teacher associated with a particular student on behalf of whom the check-in is being executed. For example, the user interface permits input update time information, student name information, among other options.

The user interface permits entry of status information (e.g., completed, unreachable, left message, among other options). In one example, the user interface permits entry of a communication type (e.g., phone, visit, in person, email, among other options). In further example the user interface accepts input of success evaluation. In one example, success or efficacy can be evaluated on a scale of 1 to 10. In other examples different scoring systems can be used to determine if an intervention was successful, or beneficial. In further embodiments, subsequent activity (e.g., reduce absenteeism, increase absenteeism, reduced number, frequency, or severity of incidents, increased number, frequency, or severity of incidents, etc.) can be used to determine a scoring of efficacy automatically, and the scores can be used in proposing an intervention, and/or selecting an intervention automatically.

According to some embodiments, free-form text fields may also be displayed. Free-form text fields permit human operators to specify additional information about an intervention including indicators of root cause, assessments about important information, and optionally includes requests for improving subsequent interventions.

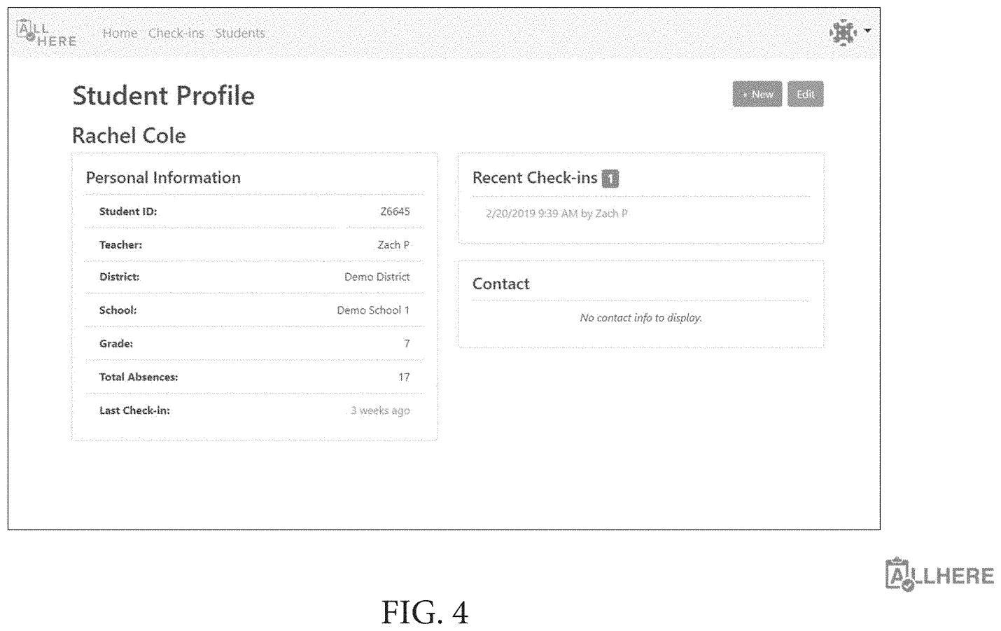

FIG. 4 is one embodiment of an example user interface displayed by the system. The user interface shown in FIG. 4 displays information on a student profile. The student profile can include student ID, teacher, district, school, grade, total absences, last check-in, among other options. In one embodiment, recent check-in information can be displayed concurrently with profile information and the recent check-in information can be accessed via a hyperlink. Additional contact information can also be displayed with profile information.

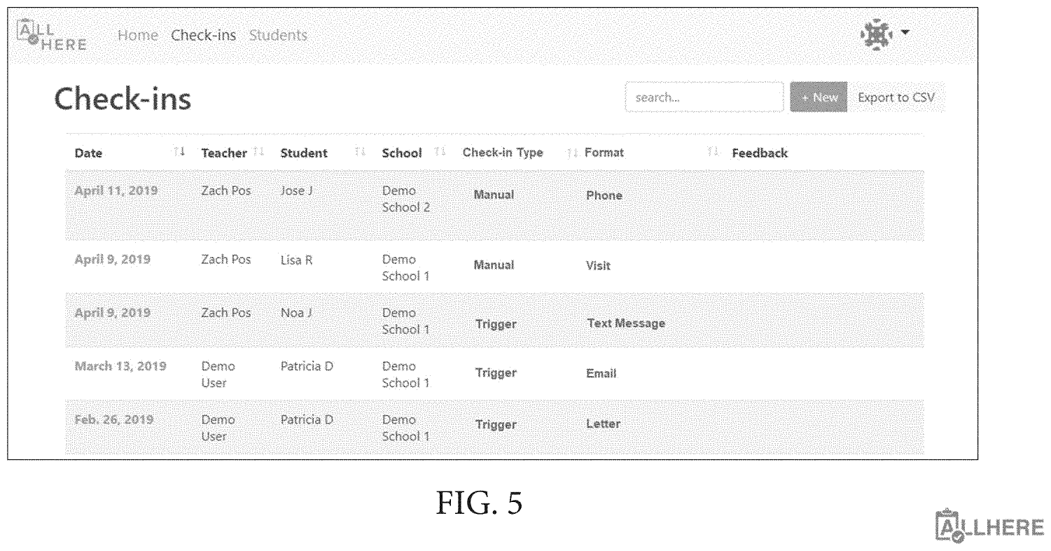

FIG. 5 is one embodiment of an example user interface display system. The user interface shown in FIG. 5 displays information on check-ins conducted using the system. As shown, the display to check ins include information on date, teacher, student, school, check-in type, check in format, feedback, among other options. In various embodiments, the user interface is configured to sort check and information based on any heading. In some examples, each check-in is selectable in the user interface. Responsive to selection, the system is configured to transition to a respective check in view.

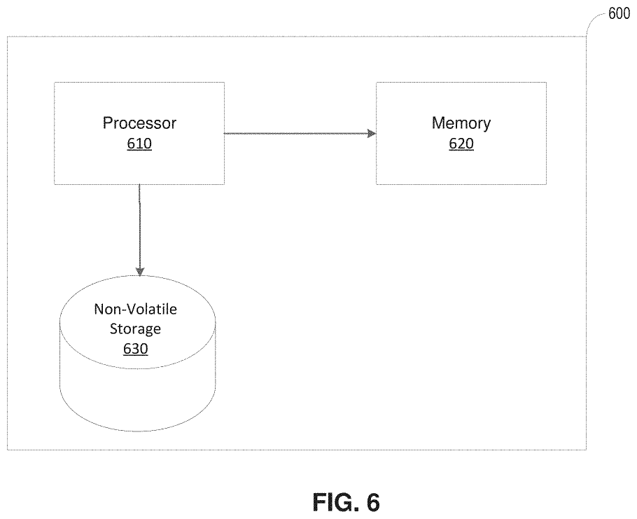

Additionally, an illustrative implementation of a computer system 600 that may be used in connection with any of the embodiments of the disclosure provided herein is shown in FIG. 6. The computer system 600 may include one or more processors 610 and one or more articles of manufacture that comprise non-transitory computer-readable storage media (e.g., memory 620 and one or more non-volatile storage media 630). The processor 610 may control writing data to and reading data from the memory 620 and the non-volatile storage device 630 in any suitable manner. To perform any of the functionality described herein (e.g., image reconstruction, anomaly detection, etc.), the processor 610 may execute one or more processor-executable instructions stored in one or more non-transitory computer-readable storage media (e.g., the memory 620), which may serve as non-transitory computer-readable storage media storing processor-executable instructions for execution by the processor 610.

### Example Monitoring and Intervention Environment

Various public school systems provides access to instruction in a variety of formats, including, for example, television stations, weekly instructional packets, and daily instruction with teachers using platforms such as Google Classroom, Google Meet and/or Zoom. In various implementation, administrators can facilitate student engagement and proactively identify and resolve issue using a monitoring and intervention platform. For example, Pupil Personnel Workers (PPW's) can play a role in the implementation of a learning plan. Among other responsibilities, they receive referrals to check in on homeless and foster care students on a weekly basis; check in on students currently on extended suspension and expulsion to ensure they are participating in the distance learning opportunities provided by their teachers; provide support to schools by contacting homes when students are not participating virtually through the distance learning opportunities offered; collaborate with principals to ensure that there are opportunities for school staff to follow-up with students/families as needed; and contact the homes of students who attend schools that have been identified by our district as having a high chronic absenteeism rate. These functions often go underutilized in conventional settings as there are not automatic systems in place to trigger such intervention, nor systems in place to automatically identify when students are in need of such intervention, and/or automatic systems to alert administrators and/or PPW's to AI identified issues and recommended interventions.

For example, the intervention system can manage identification and resolution of issues in conjunction with rule-based triggers that can automatically target select students in select schools, for example, students with an absentee rate ranging from 5-9%. The system can be configured to initiate regular contact with such students. In some alternatives, the system can automatically trigger remote communication between such students and administrators/PPW to ensure they are engaging in distance learning opportunities. In other examples, AI models can detect behavior patterns (e.g., decreased participation, decreased attendance, etc.) and trigger intervention before reaching problematic behaviors (e.g., absentee rate of 5-9% or greater). In some scenarios, PPW's manage outreach, for example, by sending letters to parents whose students are not engaged in learning according to teacher documentation, which can be identified automatically by the system and/or predictive based on modelled performance data. In addition to phone calls previously made, letters are sent via email and physical mail to parents for their response. In other embodiments, the system can manage such intervention automatically, triggering electronic and physical communication options based on modelled behavior.

The inventors have realized that because of COVID-19, the concerns over attendance and participation are significantly magnified, and that students who may have had challenges attending school under more normal circumstances are likely to face even greater obstacles to engaging in distance learning.

Accordingly various embodiments of the monitoring and intervention platform are configured to ensure that administrators have the access to interventions that are innovative and novel, and that have limited burden on district and school staff, where in some examples, interventions can be triggered by AI analysis, and even be executed by AI modeled approaches. Various learning models are configured to reduce absences at scale by monitoring student progress, keeping children engaged, identifying families in need of help, and making adjustments to meet the needs of students and staff to ensure high quality continuity of learning.

According to some embodiments, deep reinforcement learning using convolutional neural networks is implemented to provide analysis and provide predictions on interventions that will support student attendance, participation, and/or engagement. In some examples, automated chat interfaces can be provided where chat sessions are automatically triggered as an example intervention that can be identified by machine learning models. For example, conversational artificial intelligence (AI)-powered automated strategies are tailored to reduce student absenteeism at scales that cannot be managed otherwise. In further embodiments, conversational AI is implemented to efficiently support thousands of high school students by providing personalized intervention, including for example, personalized text-message based outreach and guidance for each task where they need support. In further example, AI implemented chat-bots can converse with students on their questions and issues responsive to triggers identified either in rule-based algorithms or via machine learning models.

The inventors have realized that given the capacity for AI to provide on-demand assistance, proactive outreach, move students to action, deliver a personalized experience, and learn over time, these approaches and interventions can deliver functionality that conventional systems cannot achieve nor be replicated by school administration or teaching departments.

According to various embodiments, the monitoring and intervention platform can use machine learning models that are generally applicable to student bodies, and can also execute AI that is tailored on a school by school basis, and in further example, trained on and tailored to grade based groupings and/or other classifications within one or more school systems.

Further embodiments are designed to foster strong family engagement and student attendance, while reducing rates of chronic absenteeism. Some implementations personalize each student's support within such environments to only those tasks where they are not participating or making timely progress. The system can be configured to coordinate: (1) the engagement and learning tasks required at a school, (2) capture and analyzed reliable, regularly updated data on which tasks the students had accomplished, (3) automatic responses tailored to questions families and/or students are likely or predicted to ask about these tasks, and (4) a process for the AI system to continue to refine modeled answers for queries, and learn responses to queries for which the AI may initially lack answers.

Various embodiments incorporate topical architecture tailored to specific environments, including, for example, based on a school, grade, and/or student grouping. For example, the platform can manage and execute branching message flows for more than thirty attendance topics, including recommended student schedules, student login and password support, distance learning enrichment packets, assignment submission, and engagement activities, among other options. Further AI modelling enables chat architecture that adapts to responses and/or questions presented. In further examples, AI modelling can identify options to improved success of a selected response to have a measurable effect. In addition, the platform can be augmented with research review to collaborate in the articulation of message flow topics and in the drafting and refinement of actual message content.

According to another aspect, the platform is configured for rich data capture and sharing. For example, by continuing to integrate data from the district's student information and distance learning systems, the AI Assistant can send students messages that are personalized to students' immediate needs for those domains where they are failing to participate, make progress, or where they raised questions. For example, the AI model can monitor and identify students in a population who have yet to submit assignments and trigger assignment-related outreach that can be recommended or selected by the AI model based on a predictive success evaluation.

In various embodiments, the platform is configured to build and maintain a knowledge base or behavior, issues, interventions and/or invention success information. According to some embodiments, an initial phase of operation can include seeded data to facilitate automation of responses to student or student family questions. For example, the platform can seed a knowledge base with approximately 50 frequently asked questions. Over the course of the intervention, the knowledge base is configured to grow and become a source of improved/increasing training data for training or re-training AI models. For example, the responsiveness of an AI chat-bot will expand as the knowledge base grows and is expected to exceed 1K+questions as the system learns through engagement with families and/or students.

According to one embodiment, the platform is configured to manage escalation approaches. For example, text-to-email escalation may be suggested by AI models, and in further example can be automatically executed. In some cases, the AI attendance assistant will be texted with questions that it cannot answer. When such questions are asked, the AI attendance assistant will trigger escalation functions. In one example, an attendance coach receives system notification automatically, and the questions can be forwards automatically to administration resources (e.g., to identified PPW's) via email. In further embodiments, replies are routed through the AI Assistant directly back to students and families. Such questions and responses (as well as effectiveness evaluations) can be incorporated into an AI model, so that the responses are incorporated into the AI Assistant's knowledge base. As additional questions and responses are integrated into the AI model, the AI Assistant becomes more capable and less reliant on subsequent escalation/interventions.

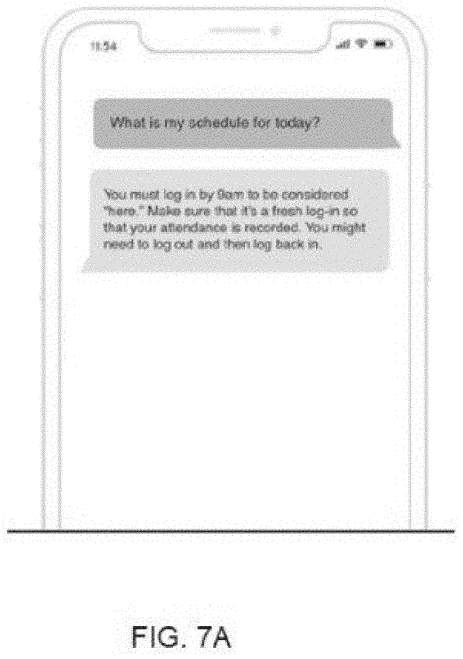

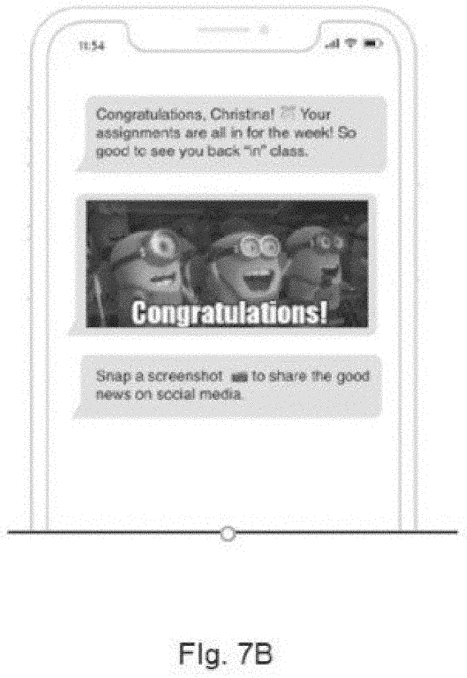

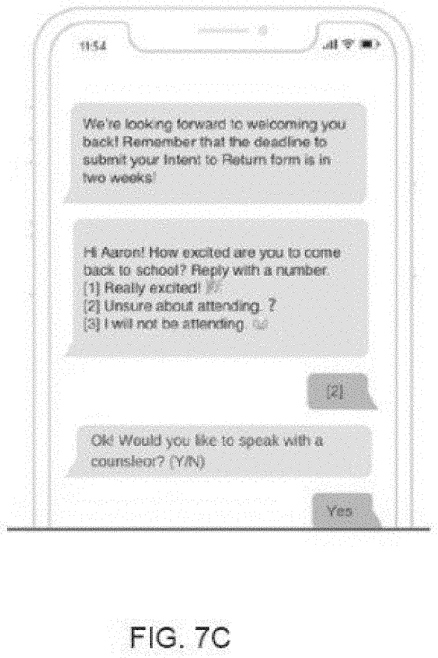

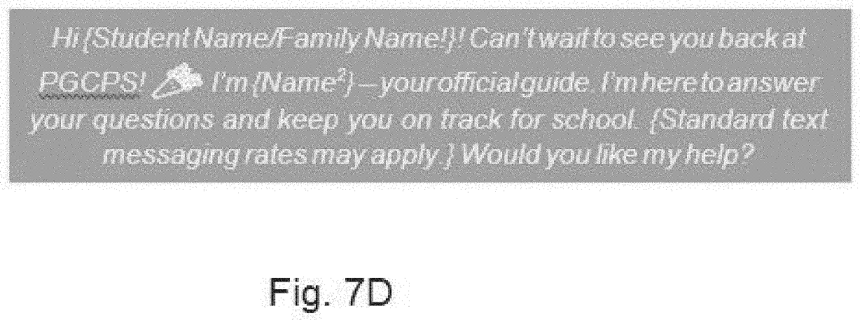

FIGS. 7A-C illustrate example screen capture and automatically generated chat streams between a respective student and an AI powered chat-bot. As illustrated, the chat prompts are tailored to improve student awareness, engagement, and interaction. In some embodiments, the chat-bot messages are configured to solicit responsive information from students. In some examples, the messages and responses can be used to refine training data and/or AI models for interacting with students. FIG. 7D illustrates an example message format for introducing the platform to students and/or families.

### Example Use Cases

According to some embodiments, the platform can be configured to define a student experience for check-in activities that enable the chat-bot to automatically reach out to enrolled students. The platform/chat-bot can be configured to target students who are now, and into the fall may be, learning from home. In one example, a check-in script can include the following questions that ask students to describe their remote learning experience. Further examples include additional questions that are tailored to revealing any additional needs for a respective student. In one example, an optional third question can be presented by the chat-bot that includes open ended questions for further evaluation.

In some embodiments, these questions are tailored to include language and branding specific to a school environment, a school district, etc. The inventors have realized that the way questions are asked impacts the way and/or context of answers, and even if the questions are answered at all. For example, students are more likely to respond if they feel their feedback and input is valued. Thus, various embodiments maintain responsiveness information for each communication, and train models to employ communications that have received more responses than others. Further embodiments can also be trained/modelled on how effective a communication was for interaction with and/or encouraging the recipient of the communication.

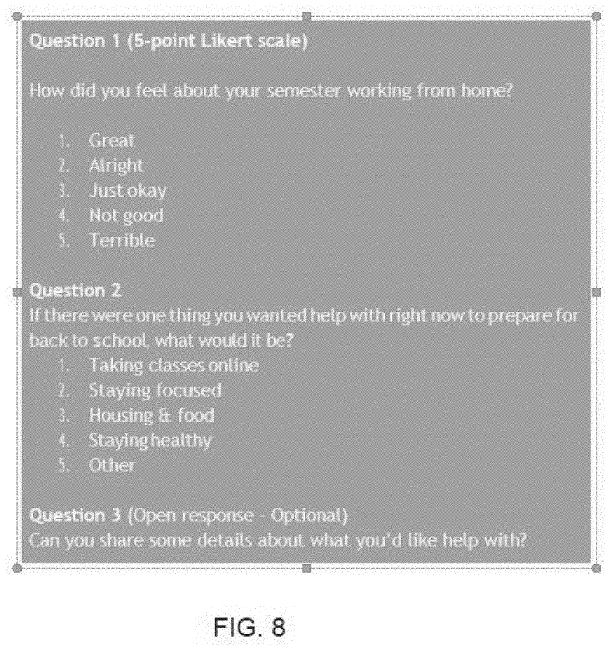

In various interaction the system is configured to acknowledge any contribution by a student or family. For example, any response is acknowledged to ensure that even automated systems and communication conveys how valued the interaction is. In some settings, the system can acknowledge a student's response with a “Thanks!” however in other settings student behavior models can trigger other acknowledgements having a greater likelihood of positive impact. For examples, the system can include options for more fun and interesting ways to word the questions to increase student engagement. FIG. 8 illustrates example questions that can be communicated.

In various embodiments, the AI Assistant is configured to send a version of a check-in survey to the enrolled students (e.g., in grades 9-12) and/or families (e.g., in grades 1-8). The system can automatically trigger additional communication, for example, based on the students' responses. It can be able to identify students who needed extra help transitioning to online learning, and direct students to helpful resources such as their PPWs. In some examples, the automated communication can even include responses for students who asks for a joke or two.

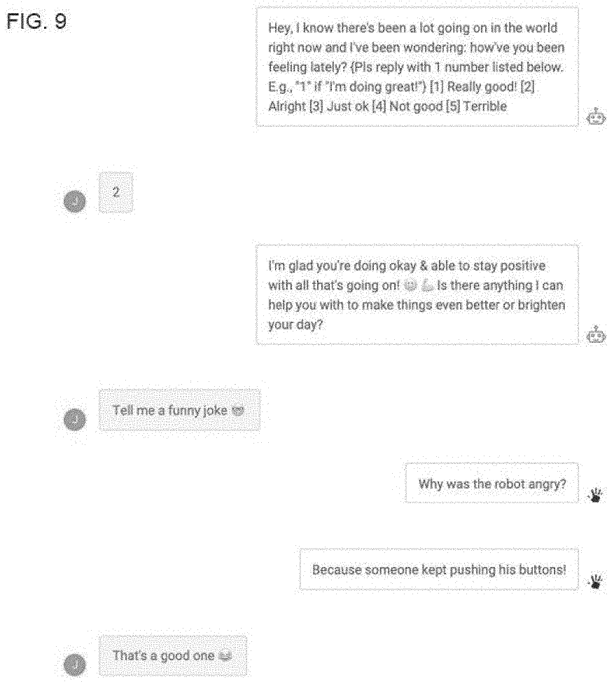

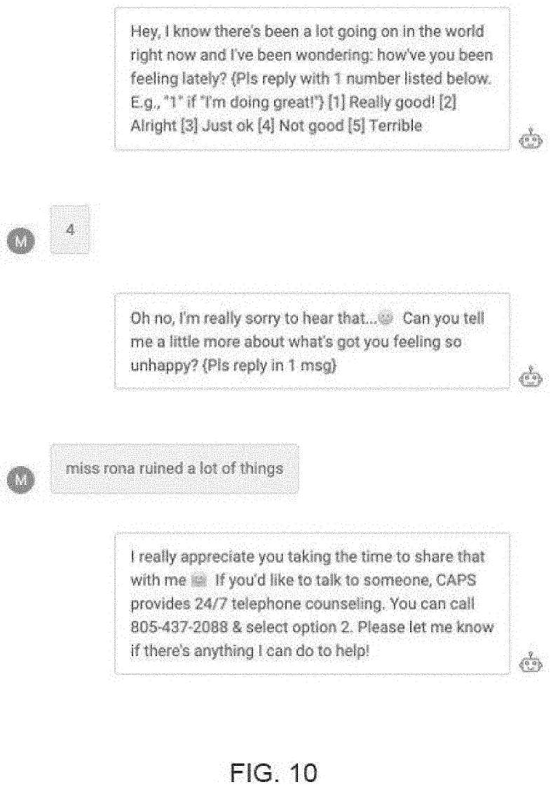

According to some embodiments, the AI managed communication is configured to elicit mood information and tailor questions and/or responses accordingly. In one example, students may be sad or upset, and the chat-bot can send a link like a resource about collective grief in this moment and inform the student on how it is okay to be sad. The platform can capture this data to provide a better analysis and trained models for understand how students and parents are doing. For example, AI moderated chat sessions are shown in FIGS. 9 and 10, and include responses selected by the AI based on student interaction, context, and may also be based on ordering of possible message based on model effectiveness.

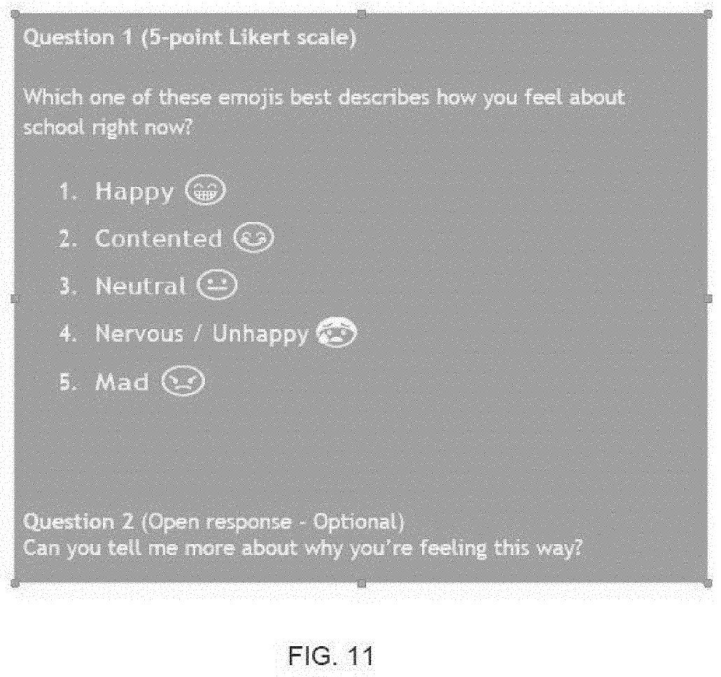

In further embodiments, the platform is configured to capture information on emotional well-being. In one example, the platform presents an emoji check in script to the enrolled students and/or student parents. Shown in FIG. 11 is an example check-in script executed by the AI Assistant, that allows the platform to take a quick student and/or parent sentiment ‘snapshot.’ The script consists of one Likert scale question and an optional open-ended question. In various embodiments, the AI Assistant is configured to identify when an inquiry on emotional well-being should be automatically trigger. In some example, well-being check-in are triggered on a schedule, but in additional and/or in the alternative the AI Assistant can model a student's behavior, engagement with class, engagement with school work, among other options and based on the modeled behavior determine that a check-in will improve understanding of root causes of any behavioral trend (e.g., good, bad, and/or different). In some examples, the AI Assistant can be configured to trigger the well-being check-in as an intervention that has been predicted to have a positive impact, for example, simply by being received.

In some examples, the system can present questions having a response scale that facilitate analysis. In other example, open ended questions can also be accepted and reviewed. In the scaled examples the system can provide feedback according to aggregate responses: “10/100 (10%) of students can report feeling ‘Great’ or ‘Neutral.’”

According to some aspects, the platform can be configured to provide a high-level analysis by breaking the 5-point scale into sentiment buckets. In some examples, the platform is configured to used buckets to help generalize that information being collects, which in some examples, facilitates modeling of well-being parameters and triggering intervention (e.g., communication intervention, touch based interventional, remote session invention, and/or real time video sessions, etc.) In some embodiments, platform is configured to build an overview on student sentiment, which can be developed in conjunction with more detailed analysis of scored well-being states. In some examples, system defined buckets could include: [1-2] Positive [3] Neutral [4-5] Negative. For each sentiment bucket and each point on the scale (e.g., FIG. 11), the system is configured to analyze and identify which topics students need help with. For example in various models generated by the system and/or AI, “In the positive bucket, 10% of students need help with ‘Staying Focused,’ or “For students who reported feeling ‘Great,’ 10% wanted help with ‘Staying Healthy,’ and 20% wanted help with ‘Housing & Food.’” In various embodiments, the AI Assistant van leverage these factors in determining that addition intervention should be communicated, and in further embodiments, the AI Assistant can automatically select targeted content based on responses. According to one embodiment, the behavioral modeling by the AI is also configured to identify similar students—even those who haven't responded—to increase and/or select interventions that can include the same or similar content.

According to another aspect, open-ended questions are presented as well. The responses are analyzed in context to the Likert-scale measurement or sentiment bucket they are attached to. For example, “Of the 40% of students who reported feeling neutral about their learning from home experience, common themes from responses to the open-ended question were: x, y and z.” Or, “For students in the positive bucket, 10% selected ‘Other’ as what they needed help with. Among their responses, common themes were identified as: x, y, and z.” In various embodiments, the AI Assistant can leverage these factors in determining that addition intervention should be communicated, and in further embodiments, the AI Assistant can automatically select targeted content based on responses. According to one embodiment, the behavioral modeling by the AI is also configured to identify similar students—even those who haven't responded—to increase and/or select interventions that can include the same or similar content.

In various embodiment, the results of such interventional are tracked, and may be the subject of survey question, to enable the system to automatically evaluate which interventions produce effective impact, and/or which interventions produced the best impact. The system can create new AI models to employ such evaluation, for example, to select the intervention predicted to have the best effect, and/or update AI models similarly.

In various environments, the platform can be configured to execute these scripts in a variety of settings: cross-sectionally, sent just once, or longitudinally, sent more than once over a period of time, among other options, including for example, based on AI analysis. Used cross-sectionally, the system is configured to capture a snapshot for how students and/or parents are feeling at any given moment. Used longitudinally, the system is configured to capture changes in student and/or parent sentiment on an emotional range over a certain period of time. In various embodiments, each approach can be used, and various approaches can be combined, used in conjunction, used in the alternative, etc.

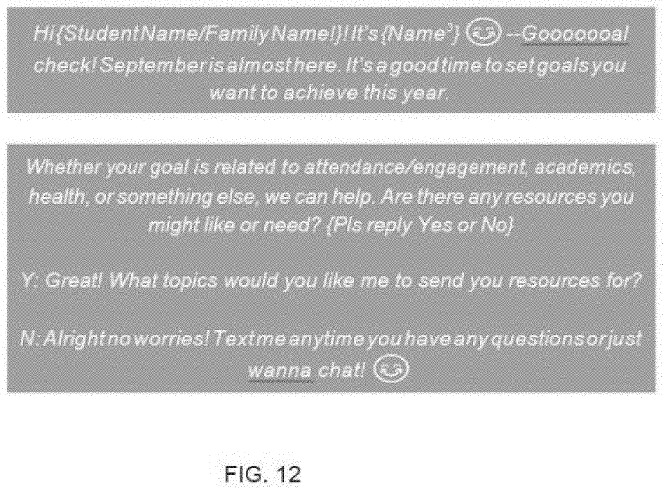

In further aspects, the platform can be configured to manage schools' goals and targets. For example, some school systems encourage students to set personal goals for the semester, and/or parents to set goals for their students. The system is configured to define targets automatically to achieve these goals, monitor progress, and automatically determined when intervention will have a positive effect on achieving those goals. FIG. 12 illustrates an example goal setting message/request. It is realized that these functions help provide a sense of belonging and set the stage for strong investment in re-entry and re-opening of schools, while also normalizing goals through a friendly nudge.

In various settings, the platform can also be tailored to manage specific goals and/or issues. One example campaign can be configured to help students who have been chronically absent historically identify barriers and constraints to engagement and participation in school. The system automatically provides resources and information, and triggers alerts/intervention to staff members for proactive resolution. Described is an example campaign targeted to incoming 9th graders to illustrate some features and capability. Other targets and recommended are also available. For example, the system can also manage outreach to any student or families of students who had been chronically absent the previous year, among other options.

According to further embodiments, the system is configured to review student performance and provide, for example, low grade alerts. In other embodiments, low grade alerts are set to threshold level and can be triggered automatically. In further embodiments, AI modeling can determine when students are trending towards the low grade threshold or other performance thresholds, and for example, predict when a student will fall below the threshold.

In some embodiments, historical data on student location and activity is compiled in associated with performance and/or engagement of various students. The data is used to train deep learning models to predict when performance issues will arise. Upon predicting a performance issue, intervention, for example as a communication session with an AI assistant can be automatically triggered. Part of the communication session in configured to capture causation information from the student as part of the communication session. Further some scripted elements can be selected by the AI assistant to automatically check-in with the student, request responses with causation information, and to request information on student perception of communication. The AI assistant and/or the system can capture causation information and effectiveness of the communication session (e.g., based on student responses, and based on further monitoring of performance). Effectiveness can be measured in various examples as improving the performance of the student having the performance issue, avoiding a predicted decline in performance, among other options. In further embodiments, improving performance can be rated higher that preventing decline, and various embodiments can score, weight, and/or value effective communication to prefer improvement over stabilizing, and greater degree of effectiveness within each category.

According to some embodiments, the system can use the above information as it is collected to build machine learning models on effectiveness of a given intervention, and used such models to order and/or selection of specific communications to be used in contact students in the same or similar context. In other example, historic information can be used to build machine learning models for ordering and/or selecting communication context. In yet others, existing models can be updated based on new training data. Last, scripted elements can even be modified or replaced based on learning context and communication style from respective students, study bodies, schools, etc.

Returning to the low grade performance example, low grade intervention can thus be dynamically triggered when modeling student information matches to a predicted low grade threshold or matches to another performance threshold (e.g., attendance. engagement, etc.), before the student grades/performance may even be affected. Other alerts thresholds and AI predictions can include low grade alerts (e.g., 1, 2, 3, 4×per month . . . ), missing assignment alerts (e.g., 1, 2, 3, 4×per week . . . ), and absence alerts (e.g., 1, 2, 3, 4×per day), and the system can provide actionable communications about students' progress to promote attendance, engagement, and reduce chronic absenteeism. According to various aspects, these interventions/communications promote a student-centric and family-focused communication strategy that incorporates research and artificial intelligence that reaches students effectively and works towards positive student outcomes. For example, by sending the right messages to the right students at the right time, the AI Assistant can enable real results without the involvement of school staff.

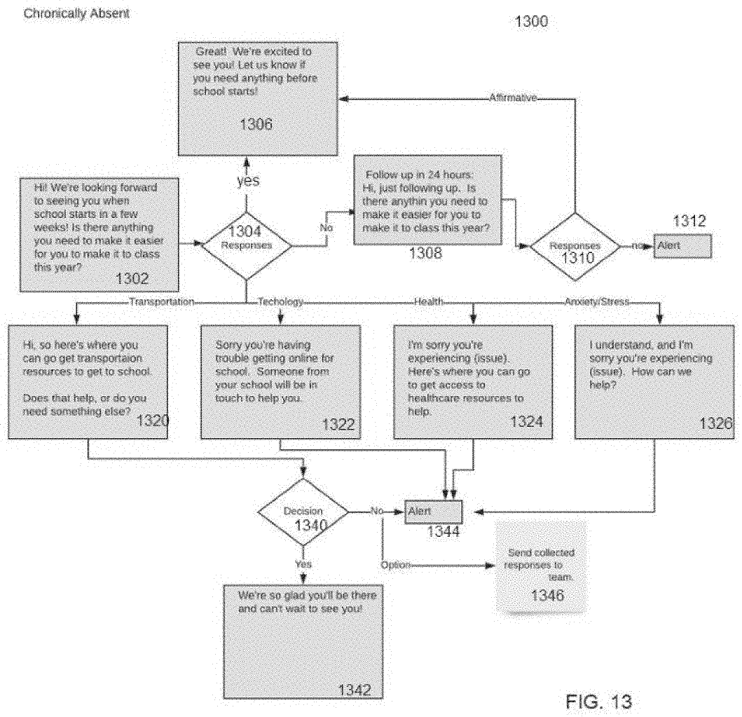

Shown in FIG. 13 is an example process flow 1300 for engaging students with chronic absence. Process 1300 can begin at 1302 with an introductory message and request for response. For example, the message can include a greeting and a notification regarding the start of a new school year. In some embodiments, the initial message presents the question for the student to respond to. At 1304, the flow continues based on whether the student responded or not. If the student responds, the student receives an acknowledgment at 1306. If not, 1304 no, the system is configured to send reminders and tailored messages until a response is received. For example, at 1308, a follow-up message is sent with the request for response. At 1310, the flow continues based on whether, or not, responses are received. If yes, an acknowledgment is sent at 1306. If no response is received from the follow-up, 1310 no, then alert is generated by the system at 1312.

According to some embodiments, the student responses trigger intelligent chat responses to convey information responsive to any issue. According to one example, process 1300 can continue at 1320 responsive to a transportation question, 1322 responsive to a technology question, at 1324 responsive to a health or safety issue, and/or at 1326 responsive to an anxiety or stress report, among other options. According to some embodiments, issues reported that can't be answered by the AI Assistant automatically can trigger generation of an alert at 1344. Shown in process 1300 is an example where an AI Assistant is configured to provide a response and request feedback on whether the response resolved a given issue. For example, process 1300 can continue at 1340 where the student responses are evaluated, and it is determined if the answers provided resolve the student issue (e.g. at 1342). If not, 1340 no, process 1300 can continue with alert generation at 1344. In some examples, if a response does not resolve the student issue further escalation can occur at 1346 where issues and responses are collected and sent to a response team. In some examples, doctor or other health care professionals can be members of response teams.

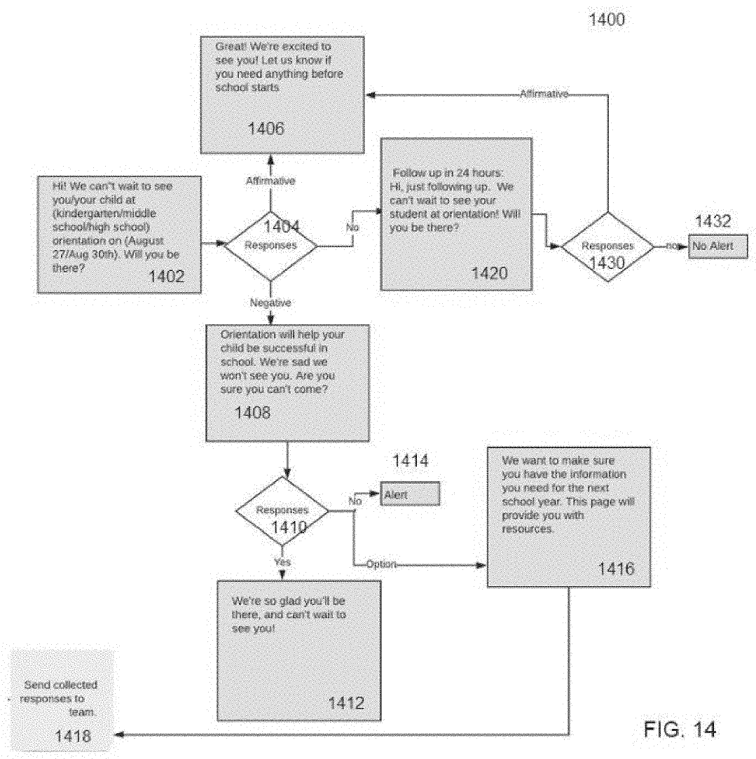

Shown in FIG. 14 14 is an example process flow 1400 for providing reminders regarding important dates or events for school. For example, process 1400 can begin at 1402 with the welcome message and request for response. According to one embodiment the welcome message includes information on orientation scheduling and options for attendance. The message may also include a request to the recipient to confirm their attendance. Responses are evaluated at 1404 and if affirmative process 1400 can conclude of 1406 with the responsive communication. If no response is received 1404 no, process 1400 continues with reminders and a reminder message at 1420. Any responses are evaluated at 1430 and if positive process 1400 can conclude at 1406. If no response is received an alert can be generated at 1432.

Process 1400 can also progress to 1408 if the recipient declines to attend (e.g. 1404 negative). In various embodiments, process 1400 continues at 1408 with the second request to attend and a request for a response. The responses are evaluated and 1410 and if the recipients still declines process 1400 can conclude, in the alternative if no response is received an alert can be generated in 1414 and optionally additional messages can be sent with information that would be provided during orientation and 1416. As part of optional processing any collected responses can be sent to the response team and 1418, which can include doctors for evaluating any response that may warrant further attention.

When responses are evaluated at 1410 if the recipient responds positively (e.g. 1410 yes), then an acknowledgment message can be sent at 1412 to conclude process 1400. FIG. 14 illustrates an example of a message sent to a younger student, including for example, a kindergarten student. Additional embodiments an additional process flows may follow a similar pathway and pattern as process flow 1400 but include different message content and advise different student bodies using different welcome messages among other options.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

1. A monitoring and response system comprising:
at least one processor operatively connected to a memory;
a monitor component, executed by the at least one processor, configured to:
automatically capture student location and activity data;
a machine learning component configured to:
match student location and activity data to student performance models; and
trigger intervention via an automated chat interface responsive to a prediction of reduced performance; and
the automated chat interface configured to:
select scripted communication elements responsive to an intervention trigger;
request responses from a respective that include student generated causal information; and
select one or more communication responses based at least in part on student response, context, and machine learning models of effective communication responses.

2. The system of claim 1, further comprising an analysis component, executed by the at least one processor, configured to:
associate student status events with causal information;
analyze student location data to determine a student status event;
analyze at least one of a student status event or student location data to automatically determine a causal identifier associated with the student status event.

3. The system of claim 1, further comprising a response component configured to:
analyze trigger information; and
automatically determine intervention options.

4. The system of claim 1, wherein the response component is configured to execute an identified intervention option automatically.

5. The system of claim 1, further comprising a communication model trained on a body of prior student communication and effectiveness of the communication.

6. The system of claim 5, wherein the communication model is configured to select communication options based on matching model parameters to a respective student.

7. The system of claim 6, wherein the communication model is further configured to manage bi-directional communication with the respective student based on matching a current communication and context to a communication option in the trained model.

8. The system of claim 7, wherein the communication model is further configured to match at least one student response and context to an alert classification.

9. The system of claim 8, wherein the system is further configured to generate and communicate an alert to a response team responsive to determining the match to the alert classification.

10. The system of claim 1, wherein the at least one processor is further configured to:
trigger scheduled communication sessions with respective students; and
automatically identify and communicate response options to returned communication from the respective students.

11. The system of claim 10, wherein the at least one processor is further configured to track communication sessions and update machine learning models based on tracked interactions.

12. A computer implemented method for monitoring and responses, the method comprising:
automatically capturing, by at least one processor, student location and activity data;
matching, by the at least one processor, student location and activity data to student performance models;
executing an intervention trigger intervention via an automated chat interface responsive to a prediction of reduced performance output by the student performance model;
selecting, by the at least one processor, scripted communication elements responsive to the intervention trigger;
requesting, by the at least one processor, responses from a respective that include student generated causal information; and
automatically selecting, by the at least one processor, one or more communication responses based at least in part on student response, context, and machine learning models of effective communication responses.

13. The method of claim 12, further comprising:
associating student status events with causal information;
analyzing student location data to determine a student status event;
analyzing at least one of a student status event or student location data to automatically determine a causal identifier associated with the student status event.

14. The method of claim 12, further comprising a response component configured to:
analyzing trigger information; and
automatically determining intervention options.

15. The method of claim 12, wherein the method further comprises executing an identified intervention option automatically.

16. The method of claim 12, further comprising executing a communication model trained on a body of prior student communication and effectiveness of the communication.

17. The method of claim 16, wherein executing the communication model includes, selecting by the communication model, communication options based on matching model parameters to a respective student.

18. The method of claim 17, wherein executing the communication model includes, managing bi-directional communication with the respective student based on matching a current communication and context to a communication option in the trained model.

19. The method of claim 17, wherein executing the communication model includes, matching at least one student response and context to an alert classification, and the method further comprises generating and communicating an alert to a response team responsive to determining the match to the alert classification.

20. The method of claim 12, wherein the method further comprises tracking communication sessions and updating machine learning models based on tracked interactions.
